(19) United States
(12) Patent Application Publication
(10) Pub. No.: US 2014/0189649 A1
(43) Pub. Date: Jul. 3, 2014

(54) Online Community-Based Expert Quality Assurance

(71) Applicant: REDSOURCE INTEREACTIVE, LLC, San Luis Obispo, CA (US)

(72) Inventor: Jeffrey Dake, Paso Robles, CA (US)

(73) Assignee: REDSOURCE INTEREACTIVE, LLC, San Luis Obispo, CA (US)

(21) Appl. No.: 13/732,428

(22) Filed: Jan. 1, 2013

(51) Int. Cl. G06F 9/44

(52) U.S. Cl. CPC G06F 8/70
USPC 717/125

(57) ABSTRACT

Systems and methods are provided for incentivizing software quality assurance professionals to join and participate in an online community focused on software quality assurance testing and discussions. Point(s) are provided for providing testing results and these points may be utilized to obtain products or services.

### FIELD OF THE INVENTION

The invention relates generally to quality assurance testing and more particularly to quality assurance testing through the use of an online network of quality assurance professionals.

### BACKGROUND OF THE INVENTION

Quality assurance testing attempts to prevent defects with a focus on the process used to make a product. The goal of quality assurance testing is to improve development and test processes so that defects do not arise when the product is being developed. Typically, quality assurance testing is performed by a manager, client, or a third-party and can be a great burden on a company. Examples of quality assurance include process checklists, project audits and methodology and standards development. Quality assurance does not concern the specific requirements of the product being developed.

Quality control on the other hand attempts to identify defects in the finished product by making certain that specific product requirements have been met. Quality control is used to verify that deliverables are of acceptable quality and that they are complete and correct.

Software quality assurance testing is a bit of a hybrid. Software quality assurance encompasses the entire software development process, which includes processes such as requirements definition, software design, coding, source code control, code reviews, change management, configuration management, testing, release management, and product integration. It ensures that any agreed-upon standards and procedures are followed, and that problems/bugs are found and dealt with.

Historically, software quality assurance testing was performed by in-house quality assurance departments, which are expensive to maintain. Some companies pay specific third party testers or testers with the most bugs reported. Recently websites such as utest.com, 99tests.com, wstf.org and others have begun to offer an alternative to in-house quality assurance departments. Some of these websites offer free testing others offer inexpensive testing while others are expensive. A problem that the free and inexpensive websites face is attracting a large enough active community of software quality assurance professionals.

In view of the foregoing, it would be advantageous to provide an improved online community of software quality assurance professionals who could perform software/website quality assurance testing. It would further be advantageous to provide such a network which incentivized participation by software quality assurance professionals.

### BRIEF SUMMARY OF THE INVENTION

Many advantages of the invention will be determined and are attained by the invention, which in a broadest sense provides systems and methods for incentivizing software quality assurance professionals to join and participate in an online community of software quality assurance professionals for the purpose of software quality assurance testing.

Systems and methods are provided for motivating software quality assurance professionals to join and participate in an online community of software quality assurance professionals who offer software quality assurance testing and discussions.

Embodiments of the invention provide a system for providing quality assurance testing via a communications network. The system includes a server connected to the communications network and the server includes a user interface and various databases. The user interface is configured to provide registration capabilities for a user and for a quality assurance professional, wherein the registration capabilities include requiring a quality assurance professional to disclose quality assurance testing qualification information. The databases include a product database configured to store product related information received from a user of the system. The product may be a software product. The databases also include a bug report database configured receive and store bug information related to the software product. The bug information is received from a quality assurance professional. A comment database is included which is configured to store at least one comment related to the bug information and an incentives database is included which is configured to store incentive information related to the quality assurance professional.

Embodiments of the invention also provide methods for providing quality assurance testing via a communications network. The methods include providing a server configured to receive and store software product information, wherein the software product information includes access information for accessing a software product. It includes receiving and storing, on the server, software product information that is received from a product developer. The method further includes receiving and storing on the server a bug report related to the software product. The bug report is received from a quality assurance professional. The method also associates a point value with the quality assurance professional subsequent to receiving the bug report. The point value may be subsequently utilized by the quality assurance professional towards making an online purchase via the communications network.

Embodiments of the invention also provide methods for providing quality assurance testing via a communications network. The methods include providing an online community for interaction between product developers who desire quality assurance testing be performed on a software product and quality assurance testing professionals. The method includes receiving product information from a product developer who desires quality assurance testing be performed on a software product. The product information includes at least access information for accessing the software product. The method also includes providing the product information for receipt by a quality assurance professional who desires to provide quality assurance testing. The method includes receiving from the quality assurance professional an identification of a bug related to the software product and providing the bug identification for receipt by the product developer. It further includes receiving a bug approval from the product developer, and in response to receipt of the approval, associating a point total with the quality assurance professional.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram of a Quality Assurance Testing system in accordance with embodiments of the invention;

FIG. 2 is a flowchart illustrating operation of a Quality Assurance Testing system in accordance with embodiments of the invention; and,

FIG. 3 is a sample display illustrating a Quality Assurance Testing system in accordance with embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

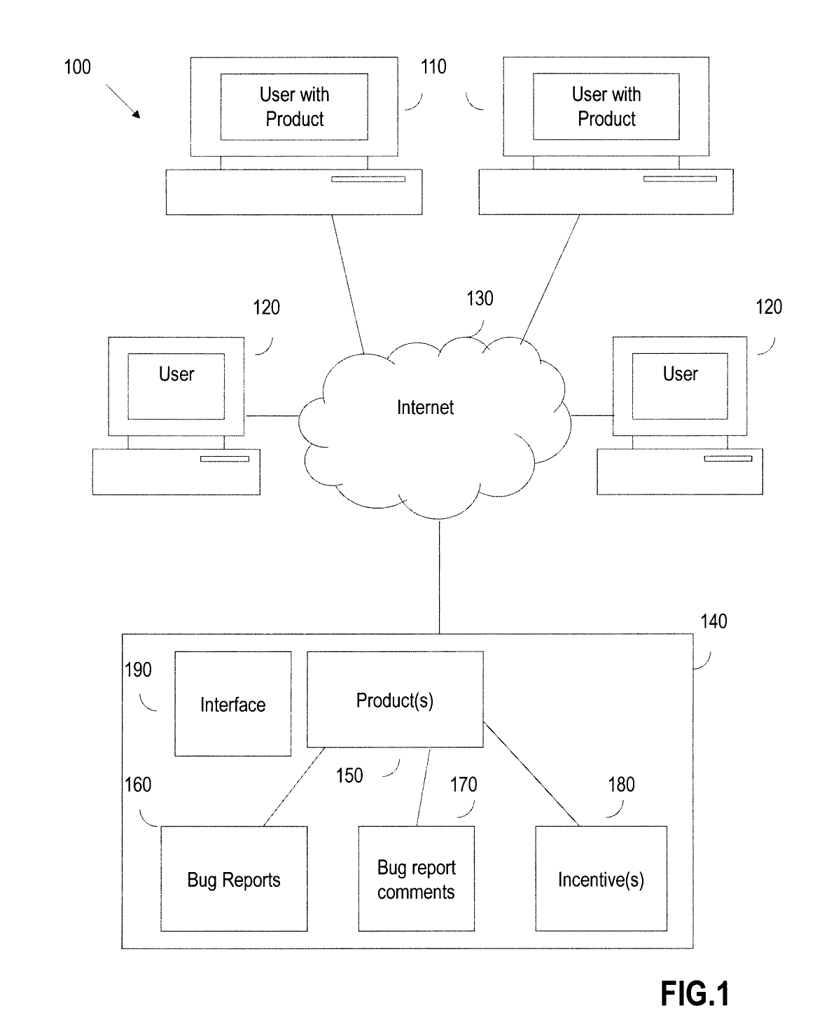

Referring to the drawings in detail wherein like reference numerals identify like elements throughout the various figures, there is illustrated in FIGS. 1-3 systems and methods for incentivizing software quality assurance professionals to join and participate in an online community focused on software quality assurance testing and discussions. While the term quality assurance professional will be used herein, the invention is not limited to persons who actually get paid for performing quality assurance testing. The term quality assurance professional is being used in its broadest sense and may include enthusiasts, hobbyists, professionals or any other person who through education, training or other means is experienced with quality assurance testing. The principles and operations of the invention may be better understood with reference to the drawings and the accompanying description.

An online community of quality assurance professionals, who interact with software developers/companies, website designers/companies, and/or any other entity who requires quality assurance testing of software, is provided (referred to herein as user 120 or product developer 120). Those skilled in the art will recognize that the term(s) software and/or software product are/is being used in its broadest sense and may refer to a software program, a website, webpage, sub-routine, source code, compiled code, mobile phone/tablet application(s) or any other coded product. For ease of explanation, the following description will be limited to software programs and websites, but the description can be applied to any or all of the various types of software and thus the invention is not so limited.

The system 100 provides incentives for participation. Such incentives may include points or partial points (for ease of explanation the following description shall only refer to points, but such usage will be understood to include points, partial points or both) that might be used to purchase products and/or services, enter drawings, games, raffles and/or job opportunities. Incentives may also or alternatively be awarded based on point accumulations. Depending upon the design choice of the system, there may be a standard point count awarded for each operation (e.g. X point(s) for posting a bug, Y point for posting the most bugs, Z points for being the first to post a bug, where X, Y and/or Z may be the same or different, etc.), there may be different point counts or levels awarded for different types or numbers of operations, points may be awarded on an objective or subjective basis, or any combination thereof. The system may be configured such that points may or may not be required for submitting a product for review or there may be an option for offering points to make a project seem more desirable. The system may provide different classification of points (e.g. submission points, response points) and require certain points to be purchased, earned and/or won. The use of incentive points will be explained in reference to the operation of the system. While certain specific point schemes will be disclosed, those skilled in the art will recognize that the invention is not intended to be limited to any one specific point scheme.

Referring to FIG. 1, in an exemplary embodiment of the invention, the system 100 includes users 110 and users 120 who connect to server 140 via the Internet 130 or via some other network. Those skilled in the art will recognize that there are various conventional ways that a user 110 or user 120 can connect to the system and that any of these methods may be employed without departing from a scope of the invention. Among such ways, although not exhaustive, are through a kiosk, direct connection, dial-up connection, a secure or unsecured connection, virtual private network (VPN), cable or satellite connection, a local area network (“LAN”), any other suitable wired, wireless, or optical connection, or a combination thereof. Those skilled in the art will also recognize that while users 110 and 120 have been set forth as separate and distinct, it is possible and anticipated that users 110 may fulfill the role of user 120 and visa-versa. Further, while 2 of each user type 110/120 have been illustrated, this was only done to avoid overcomplicating the drawing and the system is not so limited.

Server 140 includes a user interface 190 and various databases 150-180. Databases 150-180 store product (150) and bug (160) information, comments (170) and incentives earned by each user (180). Those skilled in the art will recognize that one or more of databases 150-180 may be common databases or split into multiple databases and still fall within a scope of the invention. Those skilled in the art will also recognize that while a single server 140 is illustrated that multiple servers may be employed.

User devices 110/120 may include any suitable computing equipment for accessing and interacting with content (e.g., web pages) over Internet 130 or some other communications network 130 (e.g. television network, cable network, etc.). For example, as shown in FIG. 1, user device 120 may be a desktop computer. In other examples, user device 120 may be a laptop computer, tablet computer, telephone (e.g., mobile phone), personal digital assistant (“PDA”), BlackBerry™ device, television, set-top cable or satellite box, or any other suitable computing device. Since different devices may be employed by the users, reference to any one type of device will be understood to include any or all types of suitable computing equipment. For ease of description, the remaining disclosure will only refer to user computer 110/120.

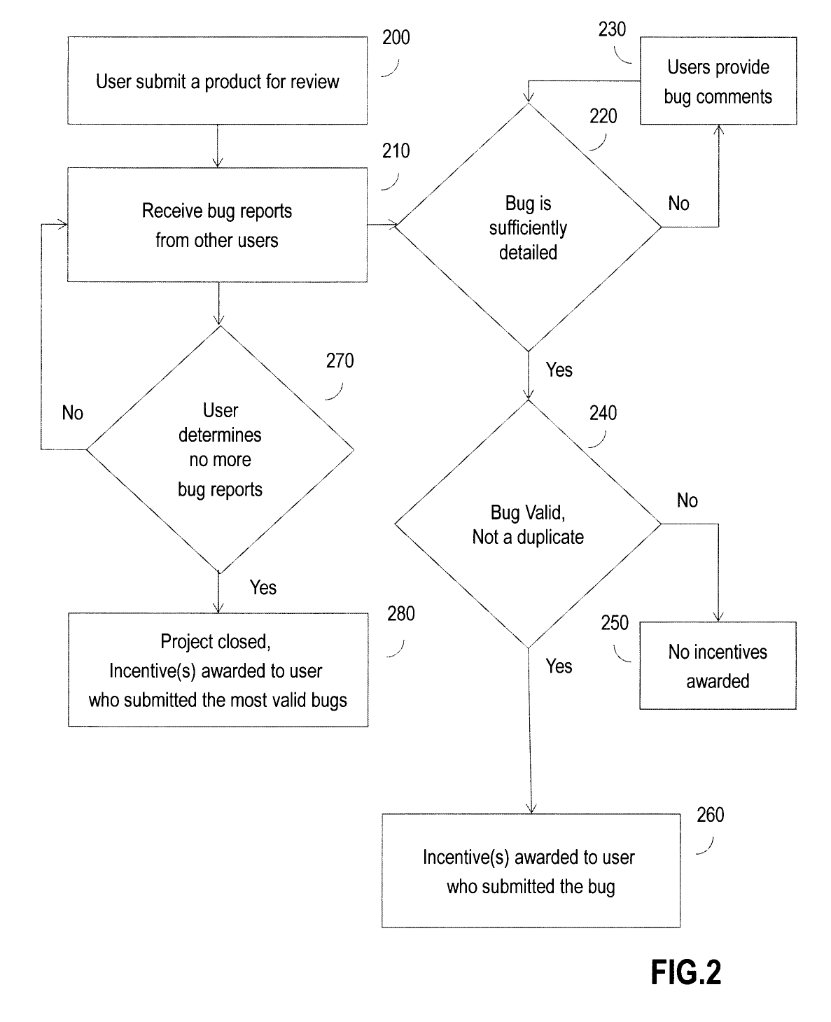

Referring to FIGS. 1 and 2, user 110/120 connects to server 140 via a user interface 190. Interface 190 may provide user 110 with various options such as register, sign-in, submit a product for review, review one or more products, review responses to previously submitted product review, or review/edit account. The system may be a closed system which requires user 110/120 to sign-in prior to submitting or reviewing products, an open system which does not require logging in or it can be a hybrid; allowing some operations to be performed without logging in and requiring log-in for other operations. For ease of explanation, the following description shall be limited to a closed system; however, this in no way is intended to limit the invention as such.

Registration: The first time user 110/120 attempts to access system 100, registration may be required. User 110/120 registers (e.g., on the System's web page or user interface 190) with system 100, and sets up their account. Registration may include entry of information such as name, unique user identification, password, contact details (e.g., e-mail, address etc.) and possibly other conventional information as may be required for the operation of the System. If a user 110/120 expects to respond to one or more requests for testing, registration may require user 110/120 to submit quality assurance qualification information.

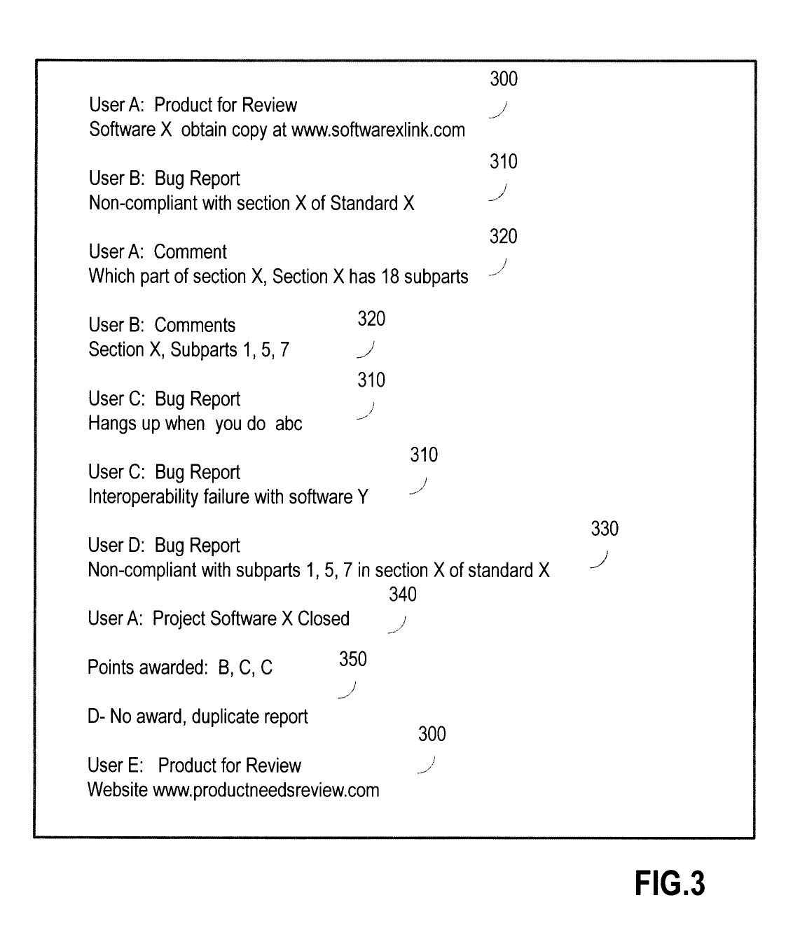

Once registered, user 110/120 may make a selection of the above operations. If user 110 decides to submit a product for review, user 110 provides the name of the product and a link for access to the product (see for example FIG. 3, examples 300). While not required, user 110 may also include a description of the type of testing needed (e.g. interoperability, industry standard compatibility, etc.). In one or more embodiments of the invention, user 110 may also be provided the option of including one or more point totals to be awarded for responses. Such point totals could be provided for each single bug/error reported, for multiple bugs reported, for the user 120 who supplies the most bug reports, for the user 120 who supplies the most obscure, hard-to-find, but potentially hazardous security bug, etc. These point totals may be the entirety of the points available for the project or they may be additional points that are added to a default point total available for a project, depending upon the design choice of the system administrator.

If, after registration and/or logging-on to the system 100, user 110 decides to provide testing for a product, user 110 scrolls through the list of available projects, performs a search for a particular project or project type (e.g. webpages, software, telephone software, ANSI standards related software, etc.) or selects a predefined project type and scrolls through the available projects listed. In one or more embodiments of the invention, the system may suggest one or more projects to user 120 based on that user's profile. Once user 110 selects a project on which to perform testing, user 110 obtains the project from user 110, typically via a hyperlink. Those skilled in the art will recognize that other conventional forms of obtaining the product for testing are available such as via US postal service, courier service, a download, etc. and thus any of these methods may be employed without departing from a scope of the invention. If user 110 determines that one or more bugs exist then user 110 provides that information to user 120 (310 in FIG. 3) by entering the bug information into the system at a location associated with the project. If user 110 provides a sufficient description of the bug and the bug is not a repeat of a bug that has already been provided then user 110 may either receive or be eligible to receive incentive points depending upon the design choice of the system administrator. If user 110 does not provide sufficient detail or is unclear in the description of the bug, user 120 may post a comment requesting additional information or clarification (320 in FIG. 3). User 110 may then respond to the request for information as illustrated at 320 in FIG. 3. In the above scenario a different user 110 may request the additional/clarifying information or may respond to the request. In such a scenario, it may be possible that each user 110 shares the points for the project, receives the entire point allocation, one user receives the points or no points are allocated. Once user 120 determines that a sufficient time has elapsed or a sufficient number of bugs have been reported user 120 may close the project, at which points all remaining points (if points are distributed piecemeal) or all points are distributed. While the project is closed as far as points are concerned, it may still be possible for a user 110 to continue to post test results. While not preferred, it may be possible for user 120 to allocate one or more points to users who submit bug reports after the project is closed.

System 100 may limit the number of projects requested by user 120. This can be done by setting a maximum number of projects allowed in a time period, setting a maximum number of open projects a user 120 may have at any given time, by requiring user 120 to purchase points then use a predetermined number of points for each project (the predetermined number of points per project need not be the same for each project) or any combination thereof. System 100 could also be configured with a default time period during which a given project can remain open. This default time period could be non-extendable, extendable by choice or require the use of points or some other form of payment to extend the time period.

Thus it is seen that systems and methods are provided for incentivizing software quality assurance professionals to join and participate in an online community focused on software quality assurance testing and discussions. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, the system is described as being set up as a single server that communicates over the Internet. However, the system could also function with multiple servers configured to perform the various operations and/or communications could take place via a network other than the Internet. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for providing quality assurance testing via a communications network, the system comprising:
a server connected to the communications network, said server having:
a user interface configured to provide registration capabilities for a user and for a quality assurance professional, wherein said registration capabilities include requiring a quality assurance professional to disclose qualification assurance testing qualification information;
a product database configured to store product related information received from a user of the system, wherein said product comprises a software product;
a bug report database configured to store bug information related to said software product, which is received from a quality assurance professional;
a comment database configured to store at least one comment related to said bug information; and,
an incentives database configured to store incentive information related to said quality assurance professional.

2. The system according to claim 1 wherein said at least one comment is received from said user.

3. The system according to claim 1 wherein said at least one comment is received from said quality assurance professional.

4. The system according to claim 1 wherein said incentives database is further configured to store incentive information related to said user.

5. The system according to claim 1 further including a user computer, selectively connected to the communications network and configured to communicate said product information to said server and to display said product information and said bug report.

6. A method for providing quality assurance testing via a communications network comprising the steps of:
providing a server configured to receive and store software product information, wherein said software product information includes access information for accessing a software product;
receiving and storing, on said server, software product information received from a product developer;
receiving and storing on said server a bug report related to said software product received from a quality assurance professional; and,
associating a point value with said quality assurance professional subsequent to receiving said bug report; wherein said point value provides a potential for an additional benefit.

7. The method according to claim 6 further comprising receiving and storing, on said server, a plurality of bug reports related to said software product, wherein said plurality of bug reports are received from a plurality of quality assurance professionals, and said server withholding said point association when said bug report is determined to duplicate a bug report previously received from another of said quality assurance professionals.

8. The method according to claim 6 further including, receiving and storing a qualification from said quality assurance professional and said server validating said qualification prior to accepting receipt of said bug report from said quality assurance professional.

9. The method according to claim 6 further comprising receiving and storing a request from said product developer for additional information or clarification related to said bug report.

10. The method according to claim 9 further comprising receiving and storing a response from said quality assurance professional to said request.

11. A method for providing quality assurance testing via a communications network comprising the steps of:
providing an online community for interaction between product developers who desire quality assurance testing be performed on a software product and quality assurance testing professionals;
receiving product information from a product developer who desires quality assurance testing be performed on a software product, wherein said product information includes access information for accessing said software product;
providing said product information for receipt by a quality assurance professional who is capable of providing said quality assurance testing and who is informed that there is potential to earn a point value for providing said quality assurance testing;
receiving from said quality assurance professional an identification of a bug related to said software product and providing said bug identification for receipt by said product developer; and,
receiving a bug approval from said product developer.

12. The method according to claim 11 further comprising said product developer and said quality assurance professional registering with said online community prior to interacting with said community.

13. The method according to claim 11 wherein said bug identification relates to an interoperability issue with another software product.

14. The method according to claim 11 wherein said bug identification relates to a compliance issue with an industry standard.

15. The method according to claim 11 wherein said point total includes a default point total and a subjective point total.

16. The method according to claim 11 further comprising said product developer having a set of points and associating at least a subset of said set of points with said product information.

17. The method according to claim 11 further comprising said product developer having a set of points and being required to use at least a subset of said points as payment for being allowed to provide said product information.

18. The method according to claim 11 further comprising receiving qualification information from said quality assurance professional prior to providing said product information for receipt by said quality assurance professional.

19. The method according to claim 11 further comprising receiving a request from said product developer for additional information or clarification related to said bug identification.

20. The method according to claim 11 further comprising
providing said product information for receipt by a plurality of quality assurance professionals who have an ability to provide said quality assurance testing;
receiving at least one bug identification respectively from at least two of said plurality of quality assurance professionals; and,
associating a point value with at least one of said quality assurance professionals.
